(19) United States
(12) Patent Application Publication
(10) Pub. No.: US 2011/0159191 A1
(43) Pub. Date: Jun. 30, 2011

(54) SENSITIZING SOLUTION FOR ELECTROLESS PLATING AND ELECTROLESS PLATING METHOD

(75) Inventors: Ichiro Koiwa, Tokyo (JP); Akira Hashimoto, Yokohama-shi (JP); Masahiko Usuda, Tokyo (JP)

(73) Assignees: SHOWA DENKO K.K., Tokyo (JP); Kanto Gakuin School Corporation, Yokohama-shi, Kanagawa (JP)

(21) Appl. No.: 13/060,640

(22) PCT Filed: Aug. 26, 2009
(86) PCT No.: PCT/JP2009/004124

§ 371 Date: Feb. 24, 2011

(30) Foreign Application Priority Data
Aug. 29, 2008 (JP) 2008222819

(51) Int. Cl. B05D 3/10; C23C 18/28

(52) U.S. Cl. 427/304; 106/1.11

(57) ABSTRACT

Provided is a sensitizing solution for electroless plating which can easily dissolve an Sn compound therein without the use of acid, and thus can be used for a long period of time without impairing the uniformity of a metal plating coating. The sensitizing solution for electroless plating is a sensitizing solution for electroless plating including: an Sn compound; and a solvent, wherein the solvent contains 10 vol. % or more of a water-soluble alcohol. In addition, provided is an electroless plating method including: a pretreatment process of immersing a body to be plated into a pretreatment solution; and a plating process of immersing the body to be plated after being subjected to the pretreatment process into a plating solution, wherein the sensitizing solution for electroless plating according to the invention is used as the pretreatment solution.

### TECHNICAL FIELD

The present invention relates to a sensitizing solution for electroless plating and an electroless plating method, and more particularly, to a sensitizing solution for electroless plating which can be used for a long period of time without impairing the uniformity of a metal plating coating, and an electroless plating method using the same.

Priority is claimed based on Japanese Patent Application No. 2008-222819, filed on Aug. 29, 2008, the content of which is incorporated herein by reference.

### BACKGROUND ART

An electroless plating method is a method of forming a metal plating coating on a body to be plated which is made of a non-conductive material such as glass, ceramic, or plastic other than metals, and is widely used for decorations, electromagnetic shielding, wiring technology such as printed-circuit boards and large-scale integrated circuits, and the like.

Typically, in a case where a metal plating coating is formed on a body to be plated using the electroless plating method, pretreatment is performed to cause a plating catalyst to adsorb onto the body to be plated. As the pretreatment, in general, a sensitizing treatment for supplying an adsorbent material to the body to be plated to accelerate the adsorption of the plating catalyst onto the body to be plated, and an activation treatment for causing the plating catalyst to adsorb onto the body to be plated are performed.

With regard to the sensitizing treatment and the activation treatment, there are a “two-solution method” in which they are separately performed using different treatment solutions and a “one-solution method” in which they are simultaneously performed using a single treatment solution. The one-solution method is widely used in industry because the number of manufacturing processes can be reduced compared to the two-solution method. In addition, the one-solution method is particularly preferably used in a case where the body to be plated is made of plastic. As a treatment solution of the one-solution method, a Sn—Pt mixed catalyst is generally used.

The two-solution method provides excellent adhesion of the metal plating coating onto the body to be plated compared to the one-solution method in a case where the body to be plated is made of glass or ceramic. Particularly, for the wiring technology such as printed-circuit boards and large-scale integrated circuits which requires high adhesion of the metal plating coating onto the body to be plated, the two-solution method is very suitable.

As a sensitizing solution used in the two-solution method, a hydrochloric acid aqueous solution of stannous chloride (SnCl₂) is known. In this sensitizing solution, Sn²⁺ ions included in the sensitizing solution are oxidized and become Sn⁴⁺ and thus are deactivated. Sn²⁺ ions are easily oxidized and become Sn⁴⁺, so that the sensitizing solution has a problem in that the applicable time is about 20 hours to 40 hours and thus is short. When the applicable time of the sensitizing solution is short, the uniformity of the metal plating coating is easily damaged, resulting in variation of quality. In addition, a renewal frequency of the sensitizing solution is increased, and thus an increase in time and effort and an increase in costs result, which is not preferable in industry.

In order to solve this problem, a sensitizing aqueous solution for electroless plating which is a sensitizing solution that contains an adsorbent material to be adsorbed onto a body to be plated through immersion of the body to be plated in the sensitizing solution, such that an adsorption site for causing a catalyst used for electroless plating to adsorb onto the surface of the body to be plated is formed on the surface of the body to be plated, and in which an absorbent oxidization and colloidization inhibitor that inhibits oxidization of the adsorbent material in the aqueous solution, inhibits colloidization and dispersion of colloidal materials in the aqueous solution, and is not easily soluble in water is added, is proposed (for example, refer to Patent Literature 1).

In addition, as a technique for providing a sensitizing solution which has a long life span, a sensitizing solution for electroless plating which is a strong acid aqueous solution containing Sn²⁺ ions, and in which, in the aqueous solution, halide ions are not practically contained, or the molar concentration of the halide ions is three times or less than the total molar concentration of the Sn²⁺ ions and Sn⁴⁺ ions, is proposed (for example, refer to Patent Literature 2).

In addition, in order to provide a sensitizing solution having a long life span, increasing the concentration of stannous chloride (SnCl₂) contained in the sensitizing solution to be high is considered. In order to increase the concentration of stannous chloride (SnCl₂) contained in the sensitizing solution to be high, the concentration of hydrochloric acid added to dissolve stannous chloride (SnCl₂) in the sensitizing solution has to be increased. However, it is known that when the concentration of hydrochloric acid contained in the sensitizing solution is increased, the life span is shortened (for example, refer to Non-Patent Literature 1).

### PATENT LITERATURE

[PTL 1] JP-A-2007-63646
[PTL 2] JP-A-2005-248287

### NON-PATENT LITERATURE

[NPL 1] Himeji Institute of Technology, MATSUDA HITOSHI: Journal of The Surface Finishing Society of Japan Vol. 55 (2004), No. 4, p. 281

### SUMMARY OF INVENTION

### Technical Problem

In the technique according to the related art, the applicable time of the sensitizing solution cannot be sufficiently lengthened. In addition, in the sensitizing solution according to the related art, when an Sn compound of stannous chloride (SnCl₂) or the like is used as the absorbent material for accelerating the adsorption of the plating catalyst onto the body to be plated, the compound needs to be dissolved in the sensitizing solution using acid such as hydrochloric acid. Acid corrodes a manufacturing apparatus or the like and thus it is preferable that the use thereof be avoided.

In order to solve the problems, an object of the invention is to provide a sensitizing solution for electroless plating which can easily dissolve an Sn compound without the use of acid, and thus can be used for a long period of time without impairing the uniformity of a metal plating coating.

Another object of the invention is to provide an electroless plating method capable of, by using a sensitizing solution that can be used for a long period of time, obtaining excellent uniformity of a metal plating coating such that variations in quality rarely result, and capable of reducing a renewal frequency of the sensitizing solution, thereby obtaining industrially high productivity.

### Solution to Problem

In order to accomplish the objects, the invention employs the following configurations:

(1) A sensitizing solution for electroless plating including: an Sn compound; and a solvent, wherein the solvent contains 10 vol. % or more of a water-soluble alcohol.

(2) The sensitizing solution according to (1), wherein the water-soluble alcohol is at least one kind selected from the group consisting of methanol, ethanol, and propanol.

(3) The sensitizing solution according to (1) or (2), wherein the Sn compound is at least one kind selected from the group consisting of SnCl₂, Sn(CH₃COCHCOCH₃)₂, SnBr₂, SnI₂, and SnSO₄.

(4) The sensitizing solution according to any one of (1) to (3), wherein the sensitizing solution is used for a pretreatment of a body to be plated made from a compound semiconductor.

(5) The sensitizing solution according to any one of (1) to (4), wherein 0.001 g/L to 200 g/L of the Sn compound is contained.

(6) An electroless plating method including: a pretreatment process of immersing a body to be plated into a pretreatment solution; and a plating process of immersing the body to be plated after being subjected to the pretreatment process into a plating solution, wherein the sensitizing solution for electroless plating according to any one of (1) to (5) is used as the pretreatment solution.

(7) An electroless plating method including: a pretreatment process of immersing a body to be plated into a pretreatment solution; and a plating process of immersing the body to be plated after being subjected to the pretreatment process into a plating solution, wherein a diluted solution obtained by diluting the sensitizing solution for electroless plating according to any one of (1) to (5), with water and/or an alcohol solution containing less than 10 vol. % of water-soluble alcohol is used as the pretreatment solution.

(8) The electroless plating method according to (6) or (7), wherein an activation process of immersing the body to be plated into an activating solution containing a plating catalyst including Pd is performed between the pretreatment process and the plating process.

(9) The electroless plating method according to (6) or (7), wherein the plating process is a silver mirror reaction.

### Advantageous Effects of Invention

Since the sensitizing solution for electroless plating according to the invention contains the Sn compound and the solvent in which the solvent contains 10 vol. % or more of the water-soluble alcohol, the sensitizing solution can be used for a long period of time without impairing the uniformity of a metal plating coating. In addition, in the sensitizing solution electroless plating according to the invention, the solvent has an excellent property of dissolving the Sn compound, so that the sensitizing solution can dissolve the Sn compound without the use of acid.

In addition, the electroless plating method according to the invention is a method in which the sensitizing solution for electroless plating according to the invention which can be used for a long period of time is used as the pretreatment solution, so that the uniformity of the metal plating coating is excellent, and variations of quality rarely result. In addition, the renewal frequency of the sensitizing solution can be reduced, so that industrially high productivity can be obtained.

In addition, in another electroless plating method according to the invention, when the diluted solution obtained by diluting the sensitizing solution for electroless plating according to invention which can be used for a long period of time with the water and/or alcohol solution containing less than 10 vol. % of water-soluble alcohol is used as the pretreatment solution, in order to enhance preservation, the concentration of the water-soluble alcohol contained in the sensitizing solution is increased to be high so as to be diluted properly for use. As a result, the Sn compound is easily dissolved using the solvent containing a high concentration of the water-soluble alcohol, and a use amount of the water-soluble alcohol contained in the pretreatment solution can be relatively decreased while maintaining a long life span of the sensitizing solution, compared to the case where the sensitizing solution for electroless plating according to the invention is used, thereby enhancing safety in the handling of the pretreatment solution.

### BRIEF DESCRIPTION OF DRAWINGS

FIG. 1 is a picture of bodies to be plated which are subjected to electroless Ni—P plating using sensitizing solutions of Experimental Examples 1 to 4 that are left as they are for 24 hours (1 day).

FIG. 2 is a picture of bodies to be plated which are subjected to electroless Ni—P plating using the sensitizing solutions of Experimental Examples 1 to 4 that are left as they are for 3 days.

FIG. 3 is a picture of bodies to be plated which are subjected to electroless Ni—P plating using the sensitizing solutions of Experimental Examples 1 to 4 that are left as they are for 5 days.

FIG. 4 is a picture of bodies to be plated which are subjected to electroless Ni—P plating using the sensitizing solution of Experimental Example 1 that is left as it is for 7 days and using the sensitizing solution of Experimental Example 1 that is left as it is for 57 days.

### DESCRIPTION OF EMBODIMENTS

Hereinafter, the invention will be described in detail.

### Sensitizing Solution

A sensitizing solution for electroless plating according to the invention contains an Sn compound and a solvent, and the solvent contains 10 vol. % or more of a water-soluble alcohol.

The sensitizing solution for electroless plating according to the invention can be used for pretreatment of a body to be plated when a metal plating coating is formed on the body to be plated which is made of a non-conductive material such as glass, ceramic, or plastic other than metals, and particularly, can be preferably used for pretreatment of a body to be plated which is made of a compound semiconductor.

It is preferable that the solvent includes only water-soluble alcohol, or includes water and water-soluble alcohol.

The kind of the water-soluble alcohol is not particularly limited, and is preferably one kind selected from the group consisting of methanol, ethanol, and propanol. It is particularly preferable that ethanol which causes the metal plating coating to obtain high adhesion to the body to be plated, has an excellent property of dissolving the Sn compound, and effectively lengthens the life span of the sensitizing solution, be used.

The concentration of the water-soluble alcohol contained in the solvent is equal to or more than 10 vol. %. However, in order to enhance the property of dissolving the Sn compound and lengthen the life span of the sensitizing solution, a higher concentration thereof is more preferable. By increasing the concentration of the water-soluble alcohol contained in the solvent to be equal to or more than 10 vol. %, a sensitizing solution which can be used for 3 days or longer can be obtained.

It is preferable that the Sn compound is at least one kind selected from the group consisting of stannous chloride (SnCl₂), stannous acetate (Sn(CH₃COCHCOCH₃)₂), stannous bromide(SnBr₂), stannous iodide (SnI₂), and stannous sulfate (SnSO₄). Particularly, it is preferable that stannous chloride which can cause the metal plating coating to obtain high adhesion to the body to be plated and has excellent economic efficiency be used.

The concentration of the Sn compound in the sensitizing solution is preferably in the range of 0.001 g/L to 200 g/L, more preferably, in the range of 0.001 g/L to 10 g/L, and most preferably, in the range of 0.05 g/L to 5 g/L. When the concentration of the Sn compound in the sensitizing solution is less than the above range, there may be a case where the effect of the Sn compound in accelerating the adsorption of a plating catalyst onto the body to be plated cannot be sufficiently obtained. In addition, when the concentration of the Sn compound in the sensitizing solution exceeds the above range, the effect obtained by containing the Sn compound cannot be further enhanced, and the life span of the sensitizing solution is shortened.

### Electroless Plating Method

Next, an electroless plating method according to the invention will be described.

First, a body to be plated which is made of glass, ceramic, plastic, or the like is prepared.

Next, a pretreatment process of immersing the body to be plated into a pretreatment solution which is the sensitizing solution according to the invention is performed. Accordingly, the Sn compound which is an adsorbent material that accelerates the adsorption of the plating catalyst onto the body to be plated is supplied to the body to be plated (sensitizing treatment).

Moreover, the sensitizing solution according to the invention can be used as the pretreatment solution as it is. However, in a case where the concentration of the Sn compound in the sensitizing solution is high enough, a diluted solution obtained by diluting the sensitizing solution with water and/or an alcohol solution containing less than 10 vol. % of water-soluble alcohol may be used.

Specifically, for example, a solution which contains a solvent only including the water-soluble alcohol and an Sn compound and thus in which the concentrations of the Sn compound and the water-soluble alcohol are high is used as the sensitizing solution, and a diluted solution obtained by diluting the sensitizing solution with water such that 0.05 g/L to 5 g/L of the Sn compound is contained is preferably used as the pretreatment solution.

Moreover, in the pretreatment process, in order to further enhance the adhesion of the metal plating coating onto the body to be plated by causing the Sn compound to be effectively adhered to the body to be plated, before immersing the body to be plated into the sensitizing solution, an alkali treatment for degreasing the surface of the body to be plated using alkali, an acid treatment using acid such as H₂SO₄, a washing treatment using water, or the like is preferably performed as needed.

Next, an activation process of immersing the body to be plated after being subjected to the pretreatment process into an activating solution containing the plating catalyst is performed. Accordingly, the plating catalyst adsorbs onto the body to be plated. As the plating catalyst, those containing Pd, Ag, or Cu may be used. It is preferable that a plating catalyst which contains Pd and thus obtains excellent adhesion be used. In addition, as the plating catalyst containing Pd, those containing PdCl₂ are preferably used.

Here, the operations of the sensitizing solution in the activation process will be described by exemplifying the plating catalyst as those containing Pd. In the activation process, Sn²⁺ ions contained in the sensitizing solution react with Pd²⁺ ions contained in the plating catalyst as follows and thus become Sn⁴⁺ ions, so that Pd precipitates. Pd generated here adsorbs onto the body to be plated as a nucleus of electroless plating.

Sn²⁺+Pd²⁺→Sn⁴⁺+Pd⁰

Moreover, in the activation process, in order to further enhance the adhesion of the metal plating coating onto the body to be plated, it is preferable that a washing treatment using water be performed before and/or after immersing the body to be plated into the activating solution.

In addition, it is preferable that processes from the pretreatment process to the activation process performed on the body to be plated be repeated several times in order to cause the plating catalyst to adsorb onto the body to be plated more reliably without staining.

The number of repetitions is, more preferably, 3 in order to obtain a sufficient effect without causing disruptions in the manufacturing processes.

Thereafter, a plating process of immersing the body to be plated after finishing the pretreatment process and the activation process into a plating solution is performed.

Here, as metals to be plated electrolessly on the body to be plated, there are Ni-based, Cu-based, Co-based, and Sn-based metals, and the like. Examples of the plating solution and a plating process conditions used here are described as follows.

### Electroless Ni—P Plating (in the Case of Glass as the Body to be Plated)

| | | |
|---|---|---|
| NiSO₄•6H₂O | 0.05 | mol |
| NH₂CH₂COOH | 0.15 | mol |
| NaH₂PO₂•H₂O | 0.20 | mol |
| Pb | 0.1 | ppm |

| | |
|---|---|
| pH | 4.5 |
| Bath temperature | 60° C. |

### Electroless Copper Plating

| CuSO₄•5 H₂O | 0.03 mol (copper sulfate) |
|---|---|
| EDTA•4 Na | 0.24 mol (ethylenediaminetetraacetic acid sodium) |
| HCHO | 0.20 mol (formaldehyde) |
| 2, 2′-bipyridine | 10 ppm (2,2′-bipyridine) |
| PEG-1000 | 100 ppm (polyethyleneglycol) |
| Bath temperature | 60° C. |
| pH | 12.5 |

Dissolved oxygen is controlled to 2 to 4 ppm while performing air agitation

### Electroless Co Plating

| | | |
|---|---|---|
| Cobalt sulfate | 0.08 | mol |
| Sodium hypophosphite | 0.2 | mol |
| Sodium tartrate | 0.5 | mol |
| Borate | 0.5 | mol |

| | |
|---|---|
| pH | 9.0 |
| Bath temperature | 90° C. |

The sensitizing solution according to this embodiment contains the Sn compound and the solvent, and the solvent contains 10 vol. % or more of the water-soluble alcohol, so that the Sn compound can be easily dissolved without the use of acid. Therefore, the sensitizing solution can be used for a long period of time without impairing the uniformity of the metal plating coating.

In addition, in the sensitizing solution according to this embodiment, in the case where the water-soluble alcohol is ethanol, high adhesion of the metal plating coating onto the body to be plated can be obtained, and the life span of the sensitizing solution can be effectively lengthened.

In addition, in the sensitizing solution according to this embodiment, in the case where the Sn compound is SnCl₂, high adhesion of the metal plating coating onto the body to be plated can be obtained.

In addition, in the electroless plating method according to this embodiment, since the sensitizing solution for electroless plating according to this embodiment which can be used for a long period of time is used as the pretreatment solution, the uniformity of the metal plating coating is excellent and thus variations in quality rarely result, and the renewal frequency of the sensitizing solution can be reduced, thereby obtaining industrially high productivity.

In addition, in the electroless plating method according to this embodiment, in the case where the diluted solution obtained by diluting the sensitizing solution for electroless plating according to this embodiment with the water and/or alcohol solution containing less than 10 vol. % of the water-soluble alcohol is used as the pretreatment solution, in order to enhance preservation, the concentration of the water-soluble alcohol contained in the sensitizing solution is increased to be high so as to be diluted properly for use. As a result, the Sn compound is easily dissolved using the solvent containing a high concentration of the water-soluble alcohol, and a use amount of the water-soluble alcohol contained in the pretreatment solution can be relatively decreased while maintaining a long life span of the sensitizing solution, compared to the case where the sensitizing solution for electroless plating according to the invention is used, thereby enhancing safety in the handling of the pretreatment solution.

Moreover, in the above-described embodiment, the case where the body to be plated is subjected to the activation process after the pretreatment process so as to be plated with metals such as Ni-based, Cu-based, Co-based, and Sn-based metals using electroless plating is exemplified. However, the invention is not limited to the embodiment. For example, the activation process may not be performed, and the body to be plated may be immersed into a plating solution containing precious metal such as Ag-based or Au-based metal in a plating process so as to be plated with the precious metal using electroless plating. Examples of the plating solution and a plating process conditions used here are described as follows.

### Electroless Silver Plating

| | | |
|---|---|---|
| AgNO₃ | 0.03 | mol |
| Glucose | 0.025 | mol |
| Ammonia | 0.15 | mol |
| KOH | 0.06 | mol |

| | |
|---|---|
| Bath temperature | 50° C. |

### Electroless Gold Plating

| | | |
|---|---|---|
| NaAuCl₄ | 0.012 | mol |
| Na₂S₂O₃ | 0.1 | mol |
| Na₂SO₃ | 0.1 | mol |
| NH₄Cl | 0.05 | mol |
| Sodium L-ascorbate | 0.25 | mol |

| | |
|---|---|
| pH | 6.0 |
| Temperature | 60° C. |

Here, in a case where a silver mirror reaction is performed in the plating process without the activation process, the operation of the sensitizing solution in the silver mirror reaction is described. In the plating process, Sn²⁺ ions contained in the sensitizing solution react with Ag¹⁺ ions contained in the plating solution as follows and become Sn⁴⁺ ions, so that Ag precipitates. Ag generated here adsorbs onto the body to be plated as a nucleus of electroless plating.

Sn²⁺+Ag¹⁺→Sn⁴⁺+Ag⁰

Even in the case where the silver mirror reaction is performed in the plating process, as in the case where metals such as Ni-based, Cu-based, Co-based, and Sn-based metals are electrolessly plated on the body to be plated by performing the activation process after the pretreatment process, the sensitizing solution for electroless plating according to this embodiment which can be used for a long period of time is used as the pretreatment solution. Therefore, the uniformity of the metal plating coating is excellent and thus variations in quality rarely result, and the renewal frequency of the sensitizing solution can be reduced, thereby obtaining industrially high productivity.

### EXAMPLES

Hereinafter, the invention will be described in detail on the basis of Examples. Moreover, the invention is not limited to Examples.

### Experimental Example 1

A sensitizing solution of Example 1 was obtained by dissolving 0.1 g of stannous chloride (SnCl₂. 2H₂O) in 1 liter of pure ethanol (EtOH). In the sensitizing solution of Example 1, an Sn compound could be easily dissolved at a concentration of 0.1 g/L without the use of acid.

### Experimental Examples 2 to 4

Sensitizing solutions (diluted solutions) of Experimental Examples 2 to 4 were obtained under the same conditions as those of Example 1 except that the sensitizing solution (stock solution) that could be obtained by dissolving 10.0 g of stannous chloride (SnCl₂.2H₂O) in 1 liter of pure ethanol (EtOH) was diluted with water so that the concentrations of ethyl alcohol were 10 vol. % (Experimental Example 2), 1 vol. % (Experimental Example 3), and 0.1 vol. % (Experimental Example 4).

Moreover, the concentration of the Sn compound in the sensitizing solution of Example 2 was 1.0 g/L, the concentration of the Sn compound in the sensitizing solution of Example 3 was 0.1 g/L, and the concentration of the Sn compound in the sensitizing solution of Example 4 was 0.01 g/L.

Using the sensitizing solutions of Experimental Examples 1 to 4 that could be obtained as described above and which were left as they were for 24 hours, electroless Ni—P plating was performed on the bodies to be plated as follows.

First, the bodies to be plated which were made of glass were subjected to ultrasonic cleaning in pure water for 5 minutes, an alkali treatment for degreasing the surfaces of the bodies to be plated using 3 mass % of caustic soda was performed for 5 minutes, an acid treatment using 3 mass % of H₂SO₄ was performed for 1 minute, and then a washing treatment using water was performed.

Thereafter, a pretreatment process of immersing the bodies to be plated into pretreatment solutions which are the sensitizing solutions of Experimental Examples 1 to 4 for 1 minute was performed. Next, the bodies to be plated after being subjected to the pretreatment process were washed with water and immersed into activating solutions for 1 minute. Then, an activation process of washing the bodies to be plated after being subjected to the activation process with water was performed. Thereafter, processes from the pretreatment process to the activation process performed on the bodies to be plated were performed 3 times.

As the activating solution, a solution obtained by dissolving 1 g of PdCl₂ in a solvent containing 10 milliliters of HCl and 4 liters of water was used.

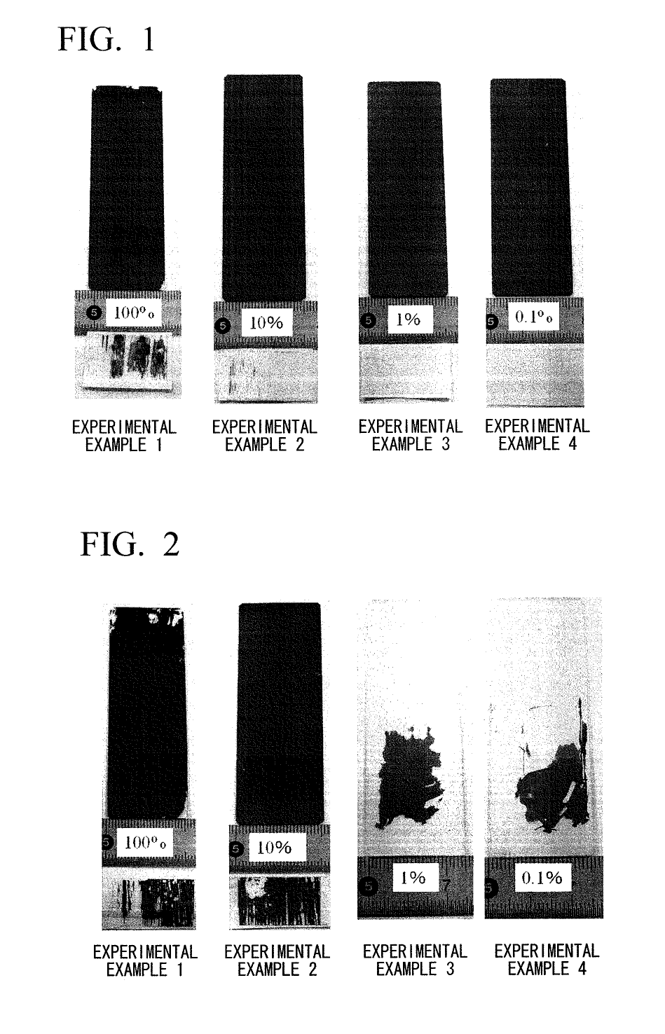

Thereafter, a plating process of immersing the bodies to be plated after finishing the pretreatment process and the activation process into the plating solution used in the above-mentioned “Electroless Ni—P Plating” (in the case of glass as the body to be plated) under conditions of pH 4.5 and a bath temperature of 60° C. for 30 minutes was performed. The results are shown in FIG. 1.

FIG. 1 is a picture of the bodies to be plated which were subjected to the electroless Ni—P plating using the sensitizing solutions of Experimental Examples 1 to 4 that were left as they were for 24 hours (1 day). As shown in FIG. 1, any of the sensitizing solutions of Experimental Examples 1 to 4 could obtain uniform metal plating coatings.

In addition, the bodies to be plated were subjected to the electroless Ni—P plating under the same conditions as those of the case using the sensitizing solutions that were left as they were for 1 day except that the sensitizing solutions of Experimental Examples 1 to 4 that were left as they were for 3 days were used. The results are shown in FIG. 2.

FIG. 2 is a picture of the bodies to be plated which were subjected to the electroless Ni—P plating using the sensitizing solutions of Experimental Examples 1 to 4 that were left as they were for 3 days. As shown in FIG. 2, in Experimental Examples 1 and 2 containing 10 vol. % or more of ethanol, uniform metal plating coatings could be obtained. However, in Experimental Example 3 containing 1 vol. % of ethanol, the deposit ratio of the metal plating coating was about 30% although the concentration of the Sn compound was the same as that in Experimental Example 1. In addition, in Experimental Example 4 containing 0.1 vol. % of ethanol, the deposit ratio of the metal plating coating was about 20%.

From the result, it could be seen that using the sensitizing solution containing 10 vol. % or more of ethanol, the life span of the sensitizing solution could be effectively lengthened.

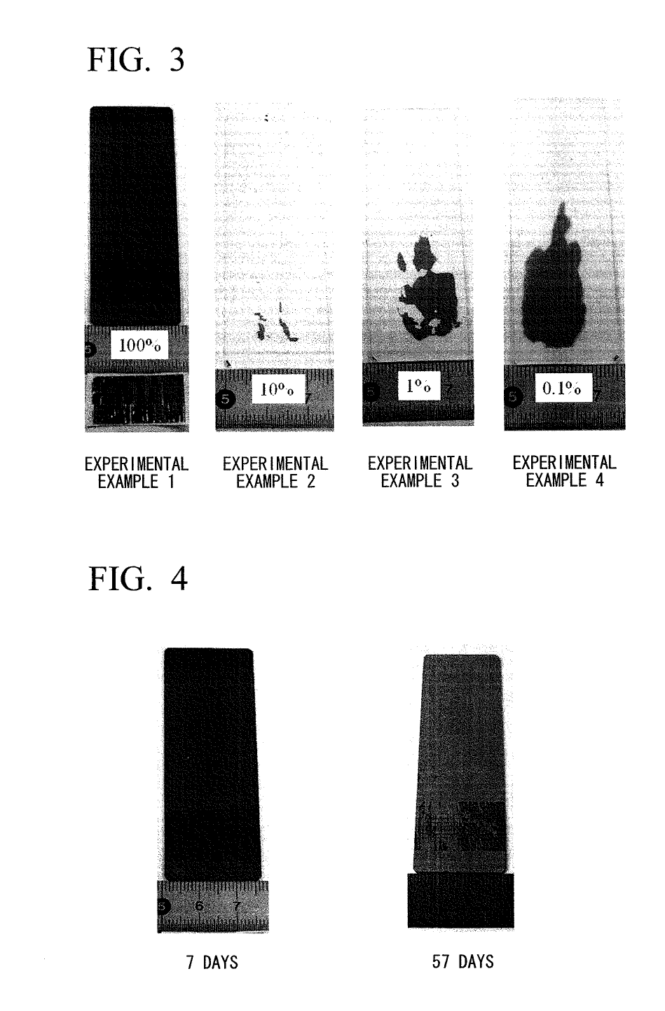

In addition, the bodies to be plated were subjected to the electroless Ni—P plating under the same conditions as those of the case using the sensitizing solutions that were left as they were for 1 day except that the sensitizing solutions of Experimental Examples 1 to 4 that were left as they were for 5 days were used. The results are shown in FIG. 3.

FIG. 3 is a picture of the bodies to be plated which were subjected to the electroless Ni—P plating using the sensitizing solutions of Experimental Examples 1 to 4 that were left as they were for 5 days. As shown in FIG. 3, in Experimental Example 1, a uniform metal plating coating could be obtained. However, in Experimental Examples 2 to 4, the deposit ratios of metal plating coatings were equal to or less than 30%.

In addition, the bodies to be plated were subjected to the electroless Ni—P plating under the same conditions as those of the case using the sensitizing solutions that were left as they were for 1 day except that the sensitizing solution of Experimental Example 1 that was left as it was for 7 days and the sensitizing solution of Experimental Example 1 that was left as it was for 57 days were used. The results are shown in FIG. 4.

FIG. 4 is a picture of the bodies to be plated which were subjected to the electroless Ni—P plating using the sensitizing solution of Experimental Example 1 that was left as it was for 7 days and using the sensitizing solution of Experimental Example 1 that was left as it was for 57 days. As shown in FIG. 4, in Experimental Example 1, both the sensitizing solutions that were left for 7 days and 57 days as they were could obtain uniform metal plating coatings.

From the results, it could be seen that the life span of the sensitizing solution of Experimental Example 1 was very long.

### Experimental Examples 5 to 8

Sensitizing solutions of Experimental Examples 5 to 8 were obtained under the same conditions as those of Experimental Example 1 except that methanol (Experimental Example 5), propanol (Experimental Example 6), ethylene glycol monoethyl ether (cellosolves) (Experimental Example 7), and lactate (Experimental Example 8) were used instead of ethanol.

In the sensitizing solutions of Examples 5 to 8, Sn compounds could be easily dissolved without the use of acid.

In addition, bodies to be plated were subjected to the electroless Ni—P plating under the same conditions as those of Experimental Example 1 except that the sensitizing solutions of Experimental Examples 5 to 8 that were left as they were for 1 day were used.

As a result, in Experimental Example 5 using methanol and Experimental Example 6 using propanol, uniform metal plating coatings could be obtained. However, in Experimental Example 7 using cellosolves and Experimental Example 8 using lactate, adhesion of metal plating coatings onto the bodies to be plated was insufficient.

### INDUSTRIAL APPLICABILITY

The invention can be applied to a sensitizing solution for electroless plating and an electroless plating method, and more particularly, to a sensitizing solution for electroless plating which can be used for a long period of time without impairing the uniformity of a metal plating coating, and an electroless plating method using the same.

1. A sensitizing solution for electroless plating comprising:
an Sn compound; and
a solvent,
wherein the solvent contains 10 vol. % or more of a water-soluble alcohol.

2. The sensitizing solution according to claim 1, wherein the water-soluble alcohol is at least one kind selected from the group consisting of methanol, ethanol, and propanol.

3. The sensitizing solution according to claim 1, wherein the Sn compound is at least one kind selected from the group consisting of SnCl₂, Sn(CH₃COCHCOCH₃)₂, SnBr₂, SnI₂, and SnSO₄.

4. The sensitizing solution according to claim 1, wherein the sensitizing solution is used for a pretreatment of a body to be plated made from a compound semiconductor.

5. The sensitizing solution according to claim 1, wherein 0.001 g/L to 200 g/L of the Sn compound is contained.

6. An electroless plating method comprising:
a pretreatment process of immersing a body to be plated into a pretreatment solution; and
a plating process of immersing the body to be plated after being subjected to the pretreatment process into a plating solution,
wherein the sensitizing solution for electroless plating according to claim 1 is used as the pretreatment solution.

7. An electroless plating method comprising:
a pretreatment process of immersing a body to be plated into a pretreatment solution; and
a plating process of immersing the body to be plated after being subjected to the pretreatment process into a plating solution,
wherein a diluted solution obtained by diluting the sensitizing solution for electroless plating according to claim 1, with water and/or an alcohol solution containing less than 10 vol. % of water-soluble alcohol is used as the pretreatment solution.

8. The electroless plating method according to claim 6, wherein an activation process of immersing the body to be plated into an activating solution containing a plating catalyst including Pd is performed between the pretreatment process and the plating process.

9. The electroless plating method according to claim 6, wherein the plating process is a silver mirror reaction.
